(19) United States
(12) Patent Application Publication
(10) Pub. No.: US 2025/0128370 A1
(43) Pub. Date: Apr. 24, 2025

(54) MACHINE TOOL AND METHOD FOR ASSEMBLING A MACHINE TOOL

(71) Applicant: BES UG (haftungsbeschränkt), Minden (DE)

(72) Inventor: Bernd BUTZER, Minden (DE)

(73) Assignee: BES UG (haftungsbeschränkt), Minden (DE)

(21) Appl. No.: 18/689,118

(22) PCT Filed: Sep. 20, 2023
(86) PCT No.: PCT/EP2023/075917

§ 371 Date: Apr. 15, 2024

(30) Foreign Application Priority Data
Sep. 30, 2022 (EP) 22198997.3

(51) Int. Cl. B23Q 1/01

(52) U.S. Cl. CPC B23Q 1/015; B23Q 1/012; B23Q 1/017

(57) ABSTRACT

A machine tool for the processing and handling of plate-shaped workpieces includes a machine table which has at least two longitudinal frame modules and at least two cross frame profiles. Each longitudinal frame module is connected to the at least two cross frame profiles by fasten, and each longitudinal frame module includes an upper flange and a lower flange which are formed from metallic profiles, and which are connected to one another via spaced posts. A guide rail for the movable mounting of a tool is supported on at least one upper flange. The posts are welded to the upper flange and the lower flange on each longitudinal frame module and each longitudinal frame module is connected to at least two cross frame modules via mechanical fastening means for forming a rack of the machine table of the machine tool.

The present invention relates to a machine tool for the processing and handling of plate-shaped workpieces with a machine table comprising at least two longitudinal frame modules and at least two cross frame profiles, wherein each longitudinal frame module is connected to the at least two cross frame profiles by fastening means and each longitudinal frame module comprises an upper flange and a lower flange, which are formed from metallic profiles, for example pipes, and which are connected to one another via spaced posts, wherein a guide rail for the movable mounting of a tool is supported on at least one upper flange, and a method for assembling a machine tool.

DE 10 2009 025 816 B4 discloses a device for processing panel-shaped workpieces, in which a large-format panel made of a wood-based material is placed on a machine table and then processed using tools. The large-format panel can also be divided into individual panel parts, which are then conveyed for further processing. The problem with such devices consists of the fact that the machine table is usually made monolithically from welded steel structures. This makes it necessary to weld the complete rack of the machine table together to form a large-volume raw body, which is difficult to transport, resulting in high assembly costs both during production and at the installation site.

This problem also exists with machines for processing sheet metal, as shown for example in DE 10 2016 120 151. Monolithic frames are also used in other machines for processing stone or in lathes.

DE 197 45 233 A1 discloses a machine tool with a frame construction in which longitudinal and vertical tubular elements are assembled and then filled with concrete and sealed.

EP 2 100 693 A1 discloses a processing device with a machine bed comprising a base section and a leg section provided at an angle thereto. The machine bed can also be formed in several parts, with the individual components being glued together or connected to each other by screws.

It is therefore the problem to be solved by the present invention to provide a machine tool for processing and handling workpieces and a method for assembling such a machine tool, which enable flexible manufacture of a machine table and effective installation at the installation site.

This problem is solved by a machine tool with the features of claim 1 and a method with the features of claim 12.

In the machine tool according to the invention, the machine table comprises at least two longitudinal frame modules and at least two cross frame modules, wherein each longitudinal frame module is connected to the at least two cross frame modules by fastening means and each longitudinal frame module comprises an upper flange and a lower flange, which are connected to one another via spaced posts, wherein a guide rail for the movable mounting of a tool is supported on at least one upper flange. On each longitudinal frame module the posts are welded to the upper flange and the lower flange and each longitudinal frame module is connected to at least two cross frame modules via mechanical fastening means to form a rack for the machine table of the machine tool. As a result, the cross frame modules and the longitudinal frame modules can be prefabricated individually in standardised dimensions and with a higher degree of automation in order to be transported to the installation site of the machine tool. These individual longitudinal frame modules are easier to handle and can be fixed together at the installation site, for example by mechanical fastening means. This modular design also leads to a high degree of flexibility in the manufacture of the machine itself as well as in the possible applications, as the longitudinal frame modules and cross frame modules can be manufactured in any size and can be combined with each other.

Preferably, the at least two longitudinal frame modules and the at least two cross frame modules are surface-treated at contact points. Such a surface treatment can be, for example, lacquering, in particular powder coating, milling, polishing or another processing method. In any case, the longitudinal frame modules and cross frame modules are first surface-treated and then assembled together in a second step so that the contact points adjacent to each other are also surface-treated. The surface treatment is thus carried out before the modules are actually assembled. The longitudinal frame modules can therefore first be welded together from the metal profiles and then coated before the cross frame modules are assembled. Assembling is therefore carried out while the longitudinal frame modules are coated.

For stable support, each cross frame module comprises a lower base profile and an upper horizontal base profile, which are connected to each other via several supporting profiles. The supporting profiles can be aligned vertically or inclined to the vertical in order to provide stable support. Optionally, the horizontal upper base profile can also be omitted for some applications, so that the cross frame module comprises only a lower base profile and vertical or inclined supporting profiles.

The machine tool is preferably equipped with a movable portal. The portal can preferably be supported on two posts, each of which can be moved along a guide rail. Tools, for example for woodworking, drilling, cutting or other mechanical processing of workpieces, as well as tools for additive manufacturing can then be provided on the portal. Additionally or alternatively, gripping tools can also be provided to lift and place the workpieces.

For exact alignment of the guide rail on the upper flange, mounting plates are preferably provided between the upper flange and the guide rail, which are fixed to the upper flange. Mounting plates between the upper flange and the guide rail can be used to compensate for height by varying the number or thickness of the mounting plates so that the guide rail is supported exactly and flat in a linear direction on the upper flange. Minor unevenness between struts of the upper flange can thus be easily levelled out. The mounting plates are preferably provided as die-cast plates made of aluminium or plastic, which are provided with sprue points so that the plates can be quickly placed on the upper flange and fixed in place with connecting means. The plates can also be mounted on the upper flange in the same thickness and then levelled at the installation site using a milling device, i.e. reduced in thickness. The levelling of the panels guarantees a very high level of precision, so that the guide rail can be mounted exactly on the panels that have been levelled by milling.

For effective assembling of the machine table, the at least two cross frame modules can be screwed to the longitudinal frame modules. Here, the screws can pretension the longitudinal frame modules towards the cross frame modules, i.e. brace them in the longitudinal direction of the cross frame modules, so that the longitudinal frame modules are precisely aligned and supported.

In a further embodiment, a section of a cross frame module and a section of a longitudinal frame module are supported on a base plate. This allows the base plates to be provided at the joints between the longitudinal frame module and the cross frame profile, so that unevenness on a surface can be easily levelled out.

In a preferred embodiment, the longitudinal frame modules with the guide rail optionally also protrude at least on one side together with the upper flange over the cross frame modules at the end. This protruding section of the longitudinal frame modules with the guide rail can be used to transport workpieces from one area of the machine table to a neighbouring position, for example a delivery pile, a conveyor belt or another processing station. An interface is thus formed in the protruding area of the guide rail so that the workpieces can be automatically fed for further processing.

Preferably, the machine table comprises a flat support for panel-shaped workpieces, for example for wood-based panels, steel sheets, aluminium panels, plastic panels or other workpieces. Such a machine table can be provided with suction devices, for example, in order to fix the workpiece completely or partially via a vacuum. Alternatively, the machine table can also be designed for other machining processes, for example with a sacrificial plate, a machining process with a cutting jet, a water jet process or a laser cutting jet. For this purpose, a tray can optionally be provided under the machine table, for example a movable collecting tray. The machine tool according to the invention can thus be used for numerous types of processing.

In a method of assembling a machine tool according to the invention, at least two longitudinal frame modules are first assembled, each comprising an upper flange and a lower flange which are connected to one another by spaced posts, the posts being welded to the upper flange and the lower flange. Furthermore, at least two cross frame modules are mounted, each including a lower base profile and one or more supporting profiles, which are aligned in particular vertically or inclined to the vertical. The longitudinal frame modules and the cross frame profiles are then surface-treated, in particular coated, for example with a lacquer, in order to then connect the longitudinal frame modules to at least two cross frame profiles via mechanical fastening means to form a rack of a machine table for the machine tool. This modular construction allows the individual longitudinal frame modules and cross frame modules to be transported effectively to the machine's installation site, where they are then fixed together using the mechanical fastening means. This significantly reduces the installation time during machine assembly.

Preferably, the longitudinal frame modules and cross frame modules are coated, in particular powder-coated, during surface treatment.

For flexible processing of workpieces, a guide rail for movable storage of the tools, in particular a portal, is preferably fixed to each upper flange of the longitudinal frame modules.

The invention is explained in more detail below with reference to the accompanying drawings. It is shown in:

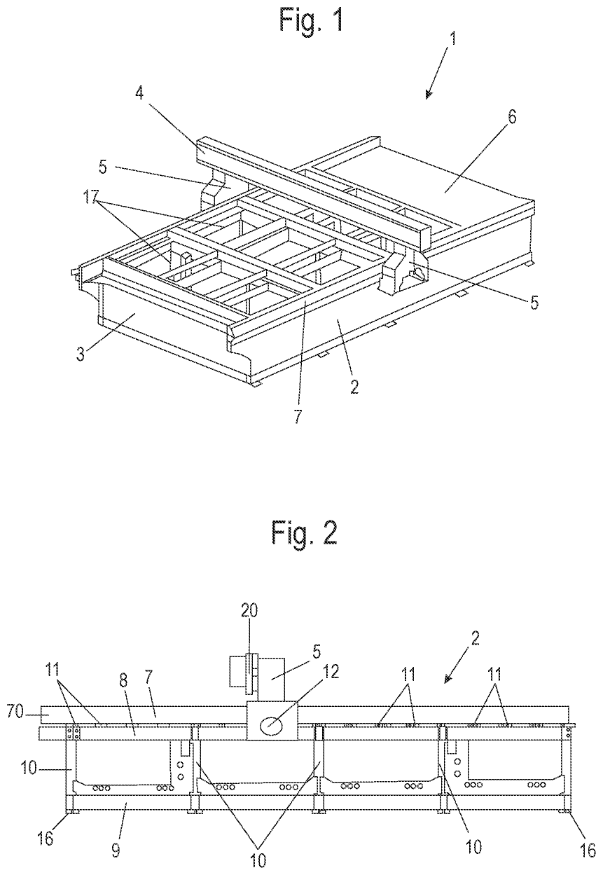

FIG. 1 a perspective view of a machine tool according to the invention;

FIG. 2: a side view of a longitudinal frame module;

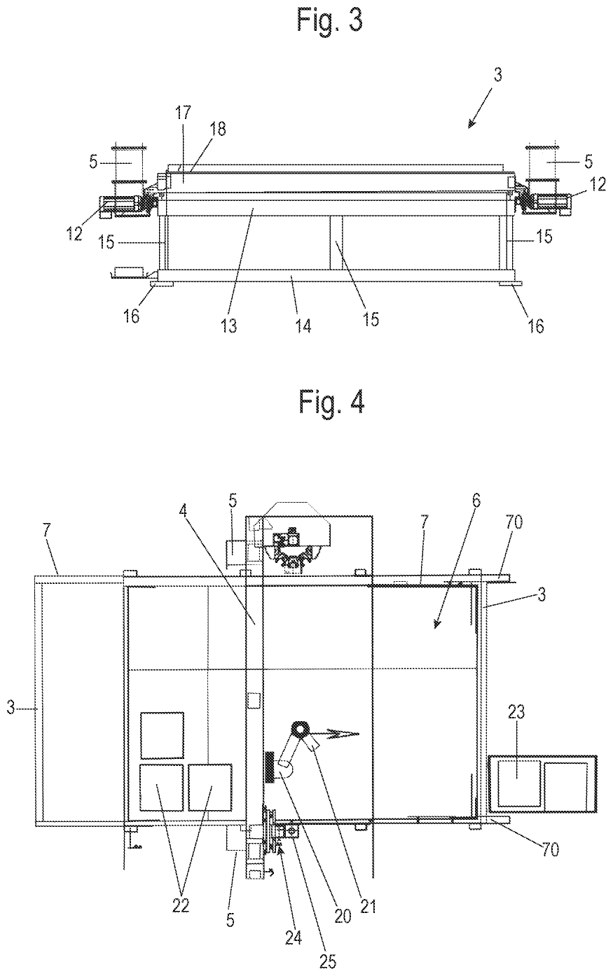

FIG. 3: a side view of a cross frame module;

FIG. 4: a top view of a machine tool;

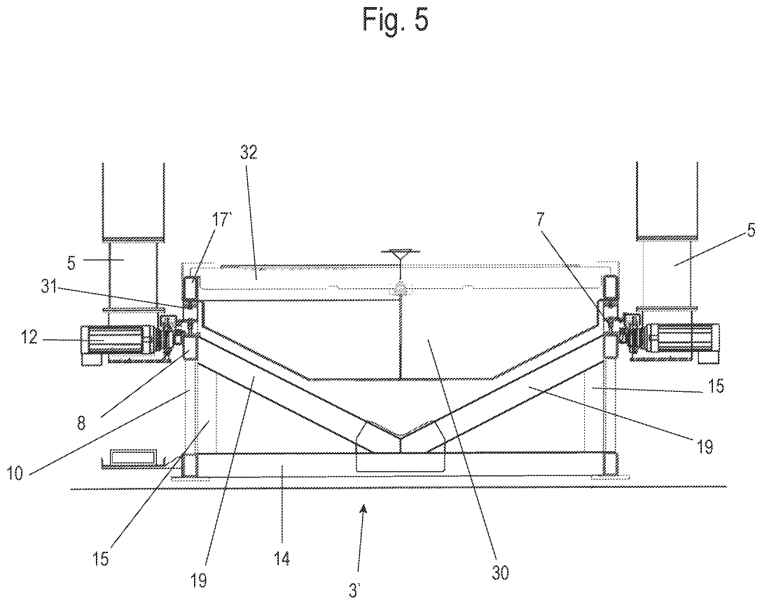

FIG. 5 a view of a modified cross frame module, and

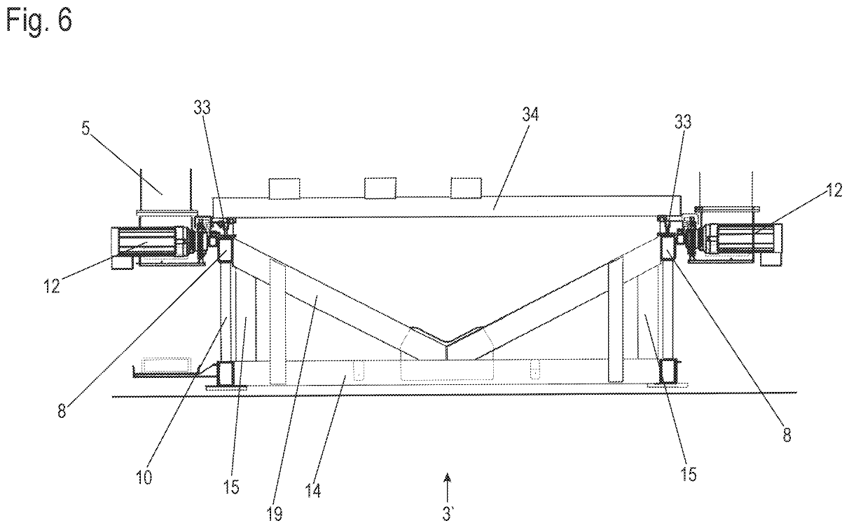

FIG. 6 a view of a modified cross frame module on a modified machine table;

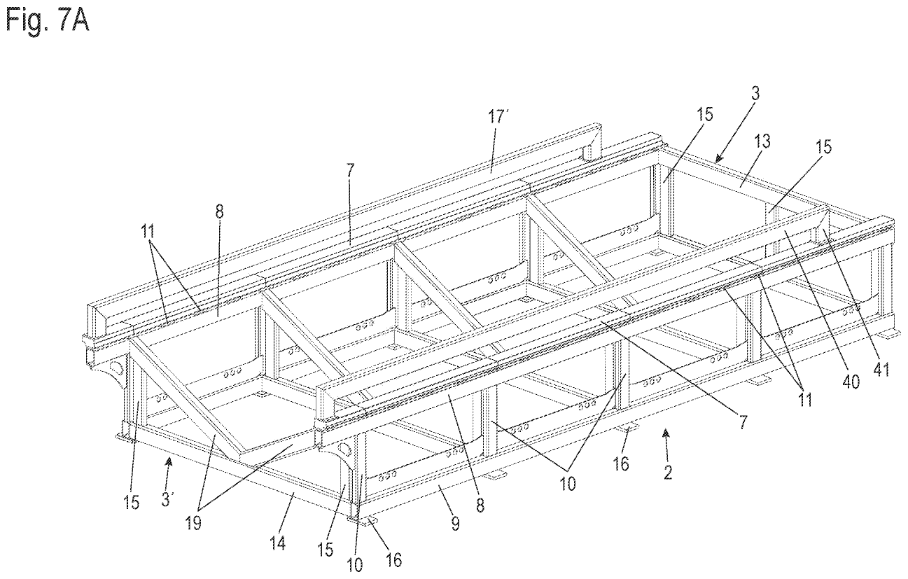

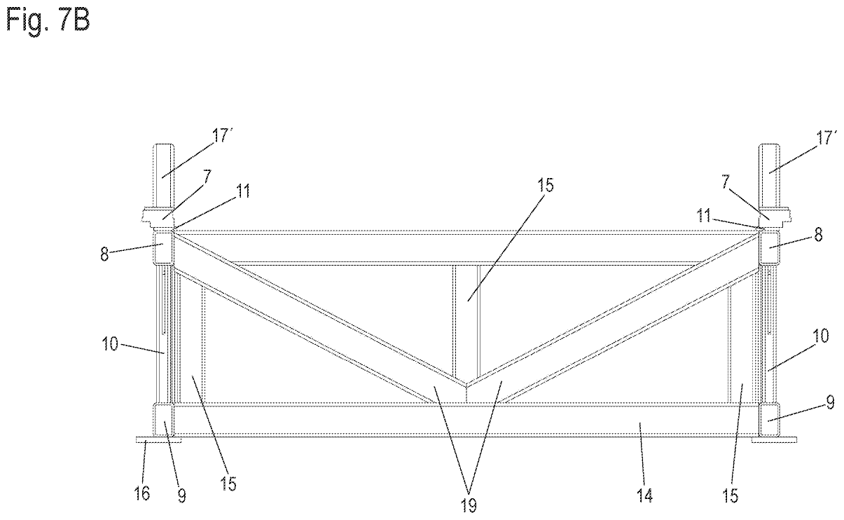

FIGS. 7A and 7B two views of a modified machine table of a machine tool according to the invention;

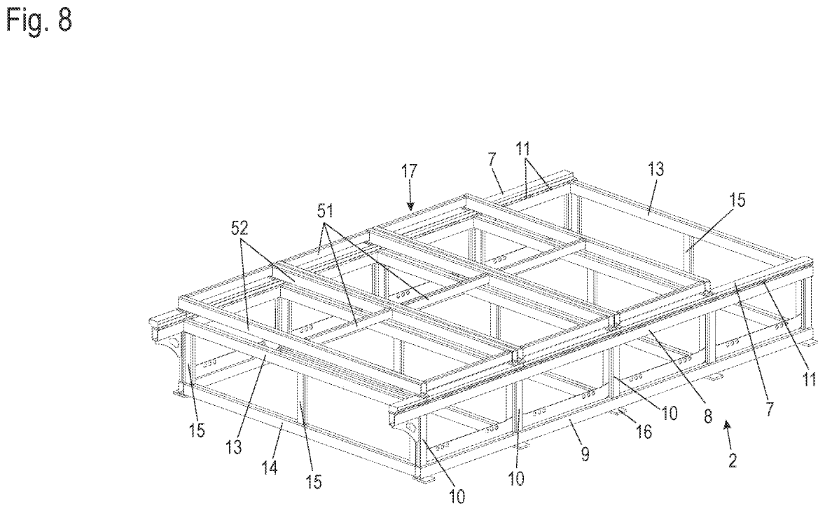

FIG. 8 a perspective view of a modified machine table of a machine tool, and

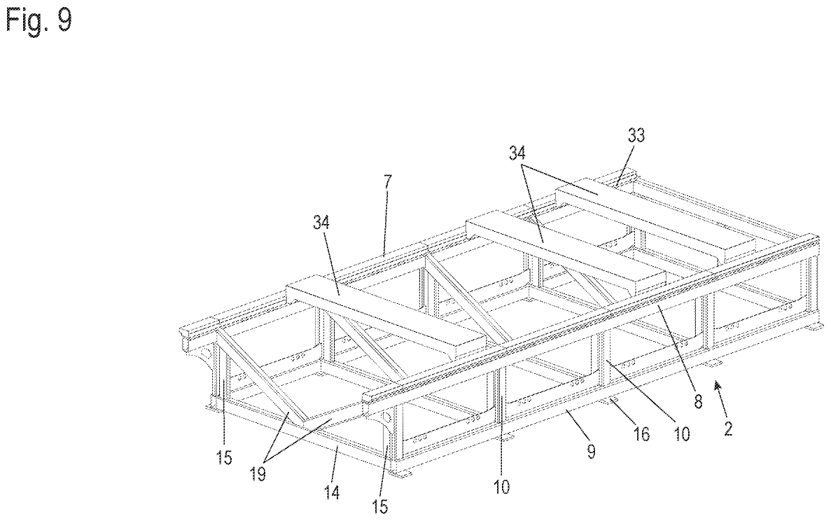

FIG. 9: a perspective view of another machine table of a machine tool.

A machine tool 1 includes two or more longitudinal frame modules 2 and two or more cross frame modules 3. The cross frame modules 3 are arranged between the longitudinal frame modules 2 and are fixed thereto by fastening means, in particular mechanical fastening means. The rack height of the longitudinal frame modules 2 and cross frame modules 3 is the same, and these thus form, in a top view from above, a circumferential rack frame which, in the assembled position, forms part of a machine table 6.

A guide rail 7 is supported on each longitudinal frame module 2, whereby a portal post 5 of a portal 4 is held movably on each guide rail 7. The portal 4 thus engages over a machine table 6, on which workpieces can be placed for processing. The workpieces can be, for example, large-format panels made of wood-based materials, plastic or metal, which are processed using tools that are held on the portal 4.

FIG. 2 shows a longitudinal frame module 2. The longitudinal frame module 2 includes an upper flange 8 and a lower flange 9, which are formed from metal profiles, for example pipes, with the upper flange 8 being supported on the lower flange 9 via a plurality of posts 10. Depending on the length of the longitudinal frame module, the number of posts 10 can be selected, which are arranged at regular intervals of between 80 cm and 1.50 m, for example. The posts 10 can be welded to the upper flange 8 and the lower flange 9 or fixed to each other using other fastening methods.

The longitudinal frame module 2 is supported on several base plates 16 in the area of the lower flange 9. Preferably, the base plates 16 are formed in such a way that a section of a lower flange 9 and an end section of a cross frame module 3 are supported on the base plate 16. A screw or other levelling element for levelling the machine can optionally be fitted in the base plate 16 in order to compensate for unevenness in the floor.

Several mounting plates 11 are provided on the upper side of the upper flange 8, which are arranged between the upper flange 8 and the guide rail 7. If individual sections of the upper flange 8 are not arranged at exactly the same height, this can be levelled by the mounting plates 11, which can be mounted in different thicknesses or mounted in the same thickness and then reduced in thickness by processing. The mounting plates 11 can be manufactured in a standardised form as a cast part. They can then be fixed and screwed to the upper flange 8 using drilled holes. Subsequently, the flatness of the mounting plates 11 can also be precisely produced over the length of the frame using a milling device. This allows the guide rail 7 to be precisely aligned in a horizontal direction and to rest on the mounting plates 11. Preferably, the guide rail 7 is fixed to the mounting plates 11 and the upper flange 8 by mechanical fastening means.

The post 5 of the portal 4 is movable on the guide rail 7, wherein a motor 12 is provided on at least one post 5, preferably on both posts 5, by means of which the portal 4 is movable in the longitudinal direction of the guide rail 7.

FIG. 3 shows a cross frame module 3 comprising a lower base profile 14 and an upper base profile 13, which are formed, for example, from tubular steel profiles. The upper base profile 13 is supported by one or more vertical posts 15, which connect the lower base profile 14 to the upper base profile 13. The cross frame module 3 has the same rack height as the longitudinal frame modules 2, and in the assembled position the cross frame module 3 can be screwed to the longitudinal frame modules 2, for example via screws that are aligned parallel to the longitudinal direction of the base profiles 13 and 14.

At least one table frame 17 is arranged above the upper base profile 13, which includes a vacuum clamping plate 18. This allows workpieces to be fixed on the upper side of the vacuum clamping plate 18 by means of negative pressure. This is particularly suitable for wood-based panels, which are divided into individual panels from large-format panels and processed. Several table frames 17 can also be mounted on the base profile 13. The width of a table frame 17 is preferably equal to the spacing of the vertically arranged posts 10 on the longitudinal frame module 2 and is equal in length to the width of the machine table 6 or the panel. In the case of FIG. 3, the table frames 17 bear forces on the guide rail 7.

FIG. 4 shows a top view of a machine table above which the portal 4 can be moved. A robot 21 for handling and/or processing workpieces 22 is fixed to the portal 4 on a movable carriage 20. The workpieces 22, which are made, for example, from split plates, can be conveyed to a delivery pile 23 via the robot 21. The delivery pile 23 is arranged adjacent to a cross frame module 3, with sections 70 of the guide rail 7 projecting beyond the end cross frame module 3, so that the portal 4 can be moved beyond the cross frame module 3 and stacks the workpieces at the delivery pile 23 or transfers them to another processing tool. For improved support of the guide rail 7, the upper flange 8 of the longitudinal frame module 2 can also protrude beyond the cross frame module 3, optionally also at both ends in the longitudinal direction, i.e. both at the front and at the rear of the machine table.

Instead of the robot 21 or in addition, other tools can also be used on the portal 4 on a carriage, for example drills, milling cutters, cutting tools or shaping tools.

Instead of the robot 21, the workpiece handling for stacking the workpieces 22 can be carried out via a lifting device 24, which is mounted on a tool carriage travelling on the portal 4. The lifting device includes at least one vertical and/or horizontal stroke for handling the workpieces 22. Such a lifting device is particularly suitable for a method for handling individual workpieces that have been cut out of a large-format panel and previously processed.

FIG. 5 shows a modified cross frame module 3′ in which no upper base profile 13 is provided, but only a lower base profile 14 and lateral posts 15. Two inclined supporting profiles 19 extend from a centre area of the lower base profile 14 to an upper area of the posts 15, so that the cross frame module 3′ has essentially the same rack height in the area adjacent to the longitudinal frame modules 2. Because of this V-shaped arrangement of the supporting profiles 19, a central area of the machine table 6 can be used for other purposes, for example for a movable collection tray 30, which is provided below an open strip table for blasting, for example for cutting processes.

The collection tray 30 can be held in a stationary position or optionally connected and moved with left/right-arranged moving carriages 31. The mechanical connection between the collection tray 30 and the portal posts 5 moves in the existing gap between the guide rail 7 and the table frame 17′ running along the existing longitudinal frame module 2, which is supported on both ends of the guide rail 7. As in the previous embodiments, the portal 4 can be moved over the strip table 32 via the portal posts 5.

FIG. 6 shows a cross frame module 3′ identical to FIG. 5, but with a further table variant. A complete table console 34 and/or table frame 17, which is arranged above or between the guide rails 7, can be moved via profile rails 33.

FIGS. 7A and 7B show a further machine table of a machine tool according to the invention, whereby it can be seen in FIG. 7A that the machine table comprises two longitudinal frame modules 2 on opposite sides, each of which comprises an upper flange 8, a lower flange 9 and a plurality of vertical posts 10 connecting the upper flange 8 to the lower flange 9. The posts 10 are welded to the lower flange 9 and the upper flange 8 and are transported to the installation site as a prefabricated unit for assembling the machine table. The two longitudinal frame modules 2 are connected to each other via several cross frame modules 3, whereby four cross frame modules 3′ are provided with V-shaped arranged supporting profiles 19 and one cross frame module 3 is provided with a central vertical post 15. Each cross frame module 3, 3′ includes a lower base profile which is connected to the longitudinal frame module 2 via mechanical fastening means. Furthermore, each cross frame module 3, 3′ has a post 15 adjacent to the longitudinal frame module 2, which is connected at the top either to the V-shaped supporting profiles 19 or to an upper base profile 13. The cross frame modules 3, 3′ can also be brought to the installation site as a prefabricated unit so that they can then be connected to the longitudinal frame modules 2. As in the previous embodiments, a plurality of mounting plates 11 are mounted on the upper flange 8 of the longitudinal frame modules 2, on which a guide rail 7 is arranged. Furthermore, a table frame 17′ in the form of a longitudinal profile is provided, which is fixed at opposite ends via an angled section on the upper side of the guide rail 7.

FIG. 8 shows a machine table in which the distance between the two longitudinal frame modules 2 is increased. The two longitudinal frame modules 2 are connected to each other via a plurality of cross frame modules 3, each of which comprises an upper base profile 13, a lower base profile 14 and at least three vertical posts 15, which connect the lower base profile 14 to the upper base profile 13, instead of the supporting profiles arranged in a V-shape. The posts 15 can be welded to the lower base profile 14 and the upper base profile 13 or fixed to each other by fastening means. On the upper side of the machine table, a table frame 17 is provided on the guide rail 7, which comprises metallic profiles 51 that are aligned parallel to the guide rails 7 and cross profiles 52 that are arranged perpendicular thereto. The table frame 17 is fixed by mechanical fastening means or welding or is attached to the guide rail 7 so that it can be moved via the profile rails 33. Preferably, the table frame 17 is formed as a lattice-shaped rack and serves as a support element for the workpiece support.

FIG. 9 shows a machine table which, similar to FIG. 7, includes two longitudinal frame modules 2 which are connected to each other via cross frame modules 3, 3′. Several table consoles 34 are provided on the upper side, which are supported on the two longitudinal frame modules 2 via a profile rail 33 on the guide rail 7 and are movable, in particular displaceable.

The illustrated embodiments can be combined with each other, for example the cross frame module 3′ can also be used with a machine tool 1 according to FIG. 1 or 2. In addition, the machine tool 1 can be used for completely different applications, depending on which workpieces are to be processed on the machine table 6.

The longitudinal frame modules 2 and the cross frame modules 3, 3′ are assembled into prefabricated units, with the profile tubes being welded together or connected to each other by mechanical fastening means. After the longitudinal frame modules 2 and the cross frame modules 3, 3′ have been manufactured, they are surface-treated, in particular coated, so that the longitudinal frame modules 2 and cross frame modules 3 can then be transported to the installation site of the machine tool 1. There, the cross frame modules 3 are then fixed to the longitudinal frame modules 2 to a produce machine tool 1. More than two longitudinal frame modules 2 and/or cross frame profiles 3 can also be connected together to form a machine table 6.

### LIST OF REFERENCE SYMBOLS

1 Machine tool
2 Longitudinal frame module
3, 3′ Cross frame module
4 Portal
5 Portal post
6 Machine table
7 Guide rail
8 Upper flange
9 Lower flange
10 Posts
11 Mounting plate
12 Motor
13 Base profile
14 Base profile
15 Posts
16 Base plate
17,17′ Table frame
18 Vacuum clamping plate
19 Support profile
20 Carriage
21 Robot
22 Workpiece
23 Delivery pile
24 Lifting device
25 Tool
30 Collection tray
32 Strip table
33 Profile rail
34 Table console
70 Sections

1. A machine tool (1) for the processing and handling of plate-shaped workpieces (22) with a machine table (6) comprising at least two longitudinal frame modules (2) and at least two cross frame modules (3), wherein each longitudinal frame module (2) is connected to the at least two cross frame modules (3) by fastening means and each longitudinal frame module (2) comprises an upper flange (8) and a lower flange (9), which are formed from metallic profiles, and which are connected to one another via spaced posts (10), wherein a guide rail (7) configured for the movable mounting of a tool is supported on at least one upper flange (8), wherein on each longitudinal frame module (2) the posts (10) are welded to the respective upper flange (8) and the lower flange (9) and each longitudinal frame module (2) is connected to the at least two cross frame modules (3, 3′) via mechanical fastening means configured for forming a rack of the machine table (6) of the machine tool (1).

2. The machine tool according to claim 1, wherein the at least two longitudinal frame modules (2) and the at least two cross frame modules (3) are surface-treated at the contact points.

3. The machine tool according to claim 1, characterised in that wherein each cross frame module (3) comprises a lower base profile (14) and an upper horizontal base profile (13), which are connected to one another via one or more supporting profiles.

4. The machine tool according to claim 1, wherein there are two of the guide rails (7) mounted at a distance from one another, and wherein a movable portal (4) is held on the two guide rails (7).

5. The machine tool according to claim 4, wherein an articulated robot (21) and/or a tool (25) is held on the movable portal (4).

6. The machine tool according to claim 4, wherein a lifting device (24) configured for handling the processed workpieces (22) is held on the movable portal (4).

7. The machine tool according to claim 1, wherein a plurality of mounting plates (11) configured for supporting the guide rail (7) are fixed on the upper flange (8).

8. The machine tool according to claim 1, wherein the at least two cross frame modules (3) are screwed to the longitudinal frame modules (2).

9. The machine tool according to claim 1, wherein a section of a cross frame module (3) and a section of a longitudinal frame module (2) are supported on a base plate (16).

10. The machine tool according to claim 1, wherein at least on one side the longitudinal frame module (2) with the guide rail (7) and the upper flange (8) protrude beyond the end of the cross frame module (3).

11. The machine tool according to claim 1, wherein the machine table (6) forms a flat support for plate-shaped workpieces (22).

12. Method A method for assembling a machine tool (1), comprising the following steps:
Assembling of at least two longitudinal frame modules (2), each comprising an upper flange (8) and a lower flange (9), which are connected to each other via spaced posts (10), wherein the posts (10) are welded to the upper flange (8) and the lower flange (9);
Assembling of at least two cross frame modules (3, 3′), each comprising a lower base profile (14) and at least one supporting profile (15, 19) orientated vertically or inclined to the base profile (14),
Surface treating the individual longitudinal frame modules (2) and the cross frame modules (3, 3′), and
Connecting the longitudinal frame modules (2) in each case to at least two cross frame modules (3, 3′) via mechanical fastening means for forming a rack of a machine table (6) for the machine tool (1).

13. The method according to claim 12, wherein the longitudinal frame modules (2) and the cross frame modules (3) are coated during the surface treatment.

14. The method according to claim 12- or 13, wherein a guide rail (7) for the movable mounting of a tool and/or a table is fixed to each upper flange (8) of the longitudinal frame module (2).

15. The method according to claim 12, wherein guide rails (7) with a movable portal (4) with a lifting device for handling the workpieces (22) are mounted on the rack of the machine table on the upper flanges (8) of the longitudinal frame modules (2).
